(19) United States
(12) Patent Application Publication
(10) Pub. No.: US 2012/0153532 A1
(43) Pub. Date: Jun. 21, 2012

(54) PLASTIC MOLDING MATERIAL AND METHOD FOR PRODUCING IT

(76) Inventors: Irene Jennrich, Winnenden (DE); Andre Zimmermann, Esslingen (DE); Frieder Sundermeier, Konwestheim (DE)

(21) Appl. No.: 13/320,698

(22) PCT Filed: Apr. 6, 2010
(86) PCT No.: PCT/EP2010/054483

§ 371 Date: Mar. 1, 2012

(30) Foreign Application Priority Data
May 15, 2009 (DE) 10 2009 003 132.4

(51) Int. Cl. B29C 71/02; C08L 63/04; C08K 3/34; C08L 79/00; C08L 39/04; C08L 63/02; B29C 45/00; C08L 63/00

(52) U.S. Cl. 264/235; 523/400; 524/589; 524/548; 523/466; 523/445; 523/457; 523/459; 524/451; 524/449; 524/456; 524/442; 523/468; 524/425; 524/424; 524/404; 524/430; 524/440

(57) ABSTRACT

A plastic molding material contains at least one filler and a polymer resin, selected from the group made up of cyanate ester resins, epoxy novolac resins, multifunctional epoxy resins, bismaleimide resins and their mixtures. The proportion of filler in the plastic molding material is in the range of 65 to 92 wt. %, with reference to the overall mass of the plastic molding material.

### BACKGROUND OF THE INVENTION

1. Field of the Invention

The present invention relates to a plastic molding material containing a polymer resin and to a method for producing such a plastic molding material and a method for producing a molded part from the plastic molding material.

2. Description of Related Art

Plastic molding materials, which contain a polymer resin that is selected from the group made up of cyanate ester resins, epoxy novolac resins, multifunctional epoxy resins, bismaleimide resins and their mixtures, as well as at least one filler, are used, for instance, in applications in which high temperatures, particularly temperatures of above 100° C. may occur. Such fields of application are engine compartments in motor vehicles, for example. In an engine compartment of a modern motor vehicle there are a series of electrical and electronic components. The appropriate connectors, such as plug connectors, switches or housings, have to be able to withstand the temperatures that occur in the engine compartment of the motor vehicle. In addition, it is required that one use materials which are easily able to be processed, are cost-effective and have electrically insulating properties.

Plastic molding material being used for such applications, as a rule, have a sustained temperature resistance up to temperatures of 180° C. Because of increasing encapsulation of engines and higher working temperatures at which the engines are operated, the application temperatures in the engine compartment of motor vehicles keep going up. However, the known plastic molding materials, from which housings, plug contacts and jacketings are being produced at this time, are no longer a match for the rising application temperatures in the engine compartment.

### BRIEF SUMMARY OF THE INVENTION

A plastic molding material according to the present invention contains a polymer resin, which is selected from the group made up of cyanate ester resins, epoxy novolac resins, multifunctional epoxy resins, bismaleimide resins and their mixtures, as well as at least one filler, the proportion of filler in the plastic molding material being in the range of 65 to 92 wt. %, with reference to the overall mass of the plastic molding material.

By the use of cyanate ester resins, epoxy novolac resins, multifunctional epoxy resins, bismaleimide resins or mixtures of these, and the high proportion of filler in the range of 65 to 92 wt. %, a plastic molding material is obtained whose sustained temperature resistance is clearly greater compared to the known plastic molding materials. Thus, the plastic molding materials according to the present invention are able to be used, for instance, in fields of application up to temperatures of 300° C. at permanent load and perhaps even up to a temperature of 380° C.

### DETAILED DESCRIPTION OF THE INVENTION

One cyanate ester resin suitable for the plastic molding material is polyphenol cyanate, for example, particularly an oligo(3-methylene-1,5-phenylene cyanate), a cyanate ester based on novolacs, a cyanate ester based on 4,4-ethylenediphenyl dicyanate, a cyanate ester based on ethylidene-bis-4,1-phenyl dicyanate or a mixture of at least two of these resins.

The cyanate ester resin may further be blended with an epoxy resin, for instance, an epoxy resin based on bisphenol A or bisphenol F and/or a cycloaliphatic epoxy resin.

Multifunctional epoxy resins, which are able to be contained in the polymer resin by themselves or in a mixture of one or more cyanate ester resins or a bismaleimide resin, are especially trifunctional or tetrafunctional epoxy resins. Particularly suitable multifunctional epoxy resins are N,N,N′,N′-tetraglycidyl-4,4′-methylenebisbenzeneamine and/or triglycidylized para-aminophenol.

Based on their duroplastic structure, the polymer resins used according to the present invention are predominantly dimensionally stable even at a high temperature, as long as the latter is below the decomposition temperature of the polymer resin.

According to the present invention, the plastic molding material contains 65 to 92 wt. %, preferably 70 to 90 wt. % and particularly 75 to 78 wt. %, in each case with reference to the overall mass of the plastic molding material, at at least one filler. The filler contained in the molding material is selected from the group made up of glass fibers, crystalline quartz, amorphous quartz, aluminum oxide, calcium carbonate, wollastonite, talcum, mica, boron nitride, silicon carbide, carbon fibers, silver with and/or without coating and mixtures thereof.

If glass fibers are used as filler, short glass fibers are preferred. The diameter of the short glass fibers is preferably in a range of 5 to 15 μm. However, alternatively to short glass fibers one may also use long glass fibers, having a length in the range of 2 to 7 mm, particularly a length in range of 3 to 4 mm, and a diameter in the range of 8 to 12 μm. The length of the glass fibers is dimensioned, in this instance, in such a way that they may be uniformly mixed with the monomer units or oligomer units, which are used as starting materials to produce the plastic molding material.

If amorphous quartz is used as filler, it may be present in splintery or spherical form or even as a mixture of splintery and spherical particles. If silver particles used as filler have a coating, the coating is preferably selected from the group made up of silanes. Because of the coating, improved connection is achieved of the particles in the matrix made of the polymer resin.

Besides the usual particle sizes of the materials used as filler, it is also possible to use nanoscale filler particles. Suitable nanoscale fillers are carbon nanotubes or carbon nanofibers, for example.

According to the present invention, the plastic molding material may contain a filler or a mixture of two or more fillers. If two or more fillers are contained, the same material may be used in different particle sizes, dimensions and/or particle shapes, or fillers having different materials are used. These may have the same shape or a similar one, or may differ from one another in shape and size. It is also possible to use fillers of conventional particle size and nanoscale fillers at the same time. Any desired mixture ratio may be used in this connection.

Amorphous quartz and or aluminum oxide are especially preferred as filler for the plastic molding material according to the present invention.

Besides polymer resin and the filler, the plastic molding material may also contain additional components and additives.

Thus, it is possible, for example, to add to the plastic molding material a silicone modifier based on cyanate esters or multifunctional epoxy resins, having a proportion in the range of 0 to 14 wt. %, preferably in the range of 1 to 3 wt. %.

The properties of the plastic molding material may be adapted to the provided use by the addition of the silicone modifier based on cyanate esters or the multifunctional epoxy resins. Properties which are able to be modified by the addition of a silicone modifier are, for instance, mechanical fracturing properties such as ductile yield, resistance to thermal change and crack growth resistance.

As silicone modifiers, low-viscosity polyorgano-silicone rubber-modified cyanate esters are suitable, for example.

Additional additives which may be contained in the molding material are, for instance, sedimentation inhibitors, wetting agents, anti-caking agents or adhesive agents. The additives may be used individually or in combination. The proportion of the additives used is usually in the range of 0.5 to 3 wt. %. The overall proportion of additives in the plastic molding material is preferably in the range of 0.5 to 1.5 wt. %.

Montmorillonite, amorphous silicon oxide or pyrogenic silicic acid are suitable as sedimentation inhibitors, for example. Of these, pyrogenic silicic acid is particularly preferred.

Wetting agents that are usually used are solutions of salts or the solution of an acid polyester, for example. A solution of an acid polyester is preferred.

A solution of an acid polyester, for example, is particularly suitable as an anti-caking agent.

Silanes are suitable as adhesive agents, for example.

In addition or alternatively to the additives named above, dyes and/or stabilizers may also be contained in the plastic molding material. If dyes are used, organic or inorganic pigments may be used. The use of inorganic pigments is preferred, in this context.

The present invention also relates to a method for producing such a plastic molding material. The method includes the following steps:

(a) preheating the resin components to a temperature in the range of 40 to 80° C.,

(b) adding preheated filler, until a filling ratio in the range of 55 to 65 wt. % is reached,

(c) adding additional filler, if necessary, in a kneading machine, a roller unit/plate unit, a two-roller mill and/or a calander.

(d) adding a catalyst after reaching a filling ratio of at least 55 wt. %.

By the method according to the present invention, one obtains a plastic molding material which is dimensionally stable even at temperatures above 180° C.

The resin components used to produce the plastic molding material may be monomer units, oligomers or prefabricated polymer material. Usually, monomer units or oligomer units or only partially cross-linked polymer units are used. Resin components usually used for producing cyanate ester resins are, for example, oligo(3-methylene-1,5-ethylenecyanate), 4,4-ethylenediphenyl dicyanate or ethylidene-bis-4,1-phenyl dicyanate. A setting agent is generally added in addition, to produce the polymer resin. If a blend of two different cyanate ester resins, or a cyanate ester and an epoxy resin and/or a bismaleimide resins is to be produced, the starting substances of the respective resins may be added together, or respective partially cross-linked basic substances are mixed together. In the addition of the respective binding agents and setting agents, usually in the form of monomer units, besides polymer blends, copolymers may also be produced.

Depending on the polymer resin used and of the processing step of the resin component, for instance, as to whether the latter is being used as monomer units or as an already prepolymerized unit, the resin components may be transferred directly into the dissolver or have to be melted first. If the resin components first have to melted, they are heated to the melting temperature. The mixing with the fillers then takes place at a temperature above the melting temperature.

The resin components for producing the polymer resin are preferably mixed preferably in a dissolver under vacuum. If additional additives are to be added to the plastic molding material, they are added together with the resin components into the dissolver. The addition of the preheated filler, until a filling ratio in the range of 55 to 70 wt. % has been reached, also takes place in the dissolver. The mixture thus prepared is then added to a kneading machine, such as a Sigma Kneading Machine, a roller unit/plate unit, a two-roller mill and/or a calander. In the kneading machine, the roller unit/plate unit, the two-roller mill and/or the calander, additional fillers may then be added. In addition, a catalyst is added to initiate the polymerization reaction. The addition of the catalyst according to the present invention, takes place, in this instance only when the filling ratio of at least 55 wt. % is reached. If the proportion of filler in the plastic molding material is greater than 70 wt. %, the addition of the catalyst preferably takes place only upon a filling ratio being reached of at least 70 wt. %. Filling ratio, in this connection, means the quantity of filler in the plastic molding material.

Metal salts, amines or Lewis acids, for example, are suitable as catalysts that are used. Suitable metal salts are, for instance, acetylacetonates, naphthenates, octoates or carboxylates of manganese, copper, cobalt or zinc. Bisphenol F or A epoxy resins are also suitable. Dicyandiamine, for example, is suitable as an amine.

Suitable Lewis acids that are able to be used as catalysts are, for instance, B(CH₃)₃, BF₃, AlCl₃ oder FeCl₃.

After the production of the molding material, it is preferably processed further in a size reduction process to form a granulate. It is also possible to produce pellets from the plastic molding material in a pressing process.

Alternatively, it is, however, also possible to follow up the molding material thus produced with a shaping process for the parts to be produced.

The molding materials according to the present invention, produced by the method according to the present invention, have a Young's modulus of elasticity in the range of 10,000 to 15,000 n/mm². The glass transition temperature of the plastic molding material thus produced is in the range of 180 to 300° C. The thermal coefficient of expansion a of the plastic molding material, according to the present invention, thus produced is in the range of 9 to 14·10⁻⁶/° C. The plastic molding materials furthermore have a tensile strength in the range of 90 to 120 N/mm², and a strain after fracture in the range of 0.8 to 1.5%.

After the production of the molding materials by the method according to the present invention, molded parts are able to be produced from the plastic molding material. The production of the molded parts takes place, in this context, either from the granulate produced before or the pellets, or, alternatively, directly after the production of the molding material from the molding material thus produced. The production of the molded part includes the following steps:

(a) producing a molded part from a molding material at a temperature in the range of 120 to 250° C., a pressure in the range of 25 to 200 bar and a retention time in the mold in a range of 20 s to 10 min.

(b) second cure of the molded part at a temperature in the range of 200 to 300° C. and a retention time in the range of 10 to 120 min.

For the production of the molded part, the molding material is injected under pressure into a tool that has a temperature in the range of 120 to 250° C. The pressure is in the abovementioned range of 25 to 200 bar, in this instance. For the injection, injection molding machines are used, or any other injection units known to one skilled in the art.

After the retention time in the heated mold, the molded part is removed and stored for an additional 10 to 120 min at a temperature in the range of 200 to 300° C. The storing may take place, for instance, in a suitable oven or a suitable heating chamber. The heating of the oven is usually done electrically.

Component parts, for example, may be produced, using the method according to the present invention, which are suitable for encasing electrical or electronic assemblies that are exposed to high thermal stress. Such electrical or electronic assemblies are, for example, plug connectors, control units, as are used, for instance, in engine compartments of motor vehicles, or inverters for photovoltaic applications.

1-12. (canceled)

13. A plastic molding material, comprising:
a polymer resin including at least one of cyanate ester resin, epoxy novolac resin, multifunctional epoxy resin and bismaleimide resin; and
at least one filler, wherein the proportion of filler in the plastic molding material is in the range of 65 to 92 wt. %, with reference to the overall mass of the plastic molding material.

14. The plastic molding material as recited in claim 13, wherein the cyanate ester resin includes at least one of a polyphenol cyanate, a cyanate ester based on novolacs, a cyanate ester based on 4,4-ethylenediphenyl dicyanate, and a cyanate ester based on ethylidene-bis-4,1-phenyl dicyanate.

15. The plastic molding material as recited in claim 13, wherein the polymer resin includes the cyanate ester resin and at least one of: (i) an epoxy resin based on one of bisphenol A or bisphenol F; and (ii) a cycloaliphatic epoxy resin.

16. The plastic molding material as recited in claim 13, wherein the multifunctional epoxy resin is one of a trifunctional or a tetrafunctional epoxy resin.

17. The plastic molding material as recited in claim 13, wherein the filler includes at least one of glass fiber, crystalline quartz, amorphous quartz, aluminum oxide, calcium carbonate, wollastonite, talcum, mica, boron nitride, silicon carbide, carbon fiber, and silver.

18. The plastic molding material as recited in claim 13, further comprising:
a silicone modifier based on one of cyanate ester or multifunctional epoxy resin is contained in a proportion in the range of 0 to 14 wt. %.

19. The plastic molding material as recited in claim 13, wherein one of a sedimentation inhibitor, wetting agent, anti-caking agent or adhesive agent is contained in the plastic molding material.

20. A method for producing a plastic molding material having (i) a polymer resin including at least one of cyanate ester resin, epoxy novolac resin, multifunctional epoxy resin and bismaleimide resin, and (ii) at least one filler, wherein the proportion of filler in the plastic molding material is in the range of 65 to 92 wt. %, with reference to the overall mass of the plastic molding material, the method comprising:
(a) preheating the polymer resin components to a temperature in the range of 40 to 80° C.,
(b) adding preheated filler, until a filling ratio in the range of 55 to 65 wt. % is reached;
(c) adding additional filler in at least one of a kneading machine, a roller unit, a two-roller mill, and a calander; and
(d) adding a catalyst after reaching a filling ratio of at least 55 wt. %.

21. The method as recited in claim 20, wherein the catalyst is selected from the group consisting of a metal salts, amines, Lewis acids, bisphenol F epoxy resins, and bisphenol A epoxy resins.

22. The method as recited in claim 21, wherein the metal salt is one of an acetylacetonate, naphthenate, octoate of manganese, carboxylate of manganese, copper, cobalt or zinc.

23. The method as recited in claim 21, wherein the amine is a dicyandiamine.

24. The method for producing a molded part from a plastic molding material having (i) a polymer resin including at least one of cyanate ester resin, epoxy novolac resin, multifunctional epoxy resin and bismaleimide resin, and (ii) at least one filler, wherein the proportion of filler in the plastic molding material is in the range of 65 to 92 wt. %, with reference to the overall mass of the plastic molding material, the method comprising:
(a) producing a molded part from the molding material at a temperature in the range of 120 to 250° C., a pressure in the range of 25 to 200 bar, and a retention time in the mold in a range of 20 s to 10 min; and
(b) providing a second cure of the molded part at a temperature in the range of 200 to 300° C. and a retention time in the range of 10 to 120 min.
